(19) United States
(12) Patent Application Publication
(10) Pub. No.: US 2007/0165638 A1
(43) Pub. Date: Jul. 19, 2007

(54) System and method for routing data over an internet protocol security network

(75) Inventors: Naader Hasani, Nepean (CA); Mohammed Ismael Tatar, Kanata (CA)

Correspondence Address: SCHWEGMAN, LUNDBERG, WOESSNER & KLUTH, P.A., P.O. BOX 2938, MINNEAPOLIS, MN, 55402, US

(73) Assignee: Cisco Technology, Inc.

(21) Appl. No.: 11/331,709

(22) Filed: Jan. 13, 2006

(51) Int. Cl. H04L 12/56

(52) U.S. Cl. 370/392

(57) ABSTRACT

A method of routing data over an Internet Protocol security (IPSec) network, the method comprising: receiving packets for transmission over the IPSec network, controlling the order of processing of the packets, determining whether each packet requires security features, feeding of the packets to a post-queue line interface module according to the order of processing the packets and allocating a sequence number to each packet in the order of feeding of packets to the post-queue line interface module. A packet requiring security features are provided with such features, which may be AH or ESP protocol, before it is transmitted over the Internet Protocol security network. As the queueing of the packet is done before the packet is provided with security features, the quality of service of the IPSec network is improved with the packets being received at the anti-replay window according to the order of the allocated sequence numbers.

### TECHNICAL FIELD

The present application relates to the field of routing data within a computer network. In an example embodiment, the application relates to improving quality of service when routing data within an Internet Protocol Security network.

### BACKGROUND

Internet Protocol Security (IPSec) is a standard providing infrastructure for supporting secure Internet Protocol (IP) communications by encrypting and/or authenticating Internet Protocol data packets. The IPSec infrastructure allows for the creation of secure tunnels within the IP network, to build a “virtual private network (VPN)” between the routing systems on the network or between two endpoints of an IP tunnel. Typically use is made of two cryptographic protocols namely Encapsulating Security Payload (ESP) that provides authentication, data confidentiality and message integrity to the packet, as well as Authentication Header (AH) which provides only authentication and message integrity to the packet.

Two distinct modes of IPSec operation exist. Transport mode is used for host-to-host security, where protection extends to the payload of the IP data. In this mode the IP addresses of the hosts must be public IP addresses. Tunnel mode is used to provide data security between two networks and protection is provided for the entire IP packet by adding an outer IP header corresponding to the two tunnel end-points. Tunnel mode hides the original IP header and accordingly provides security of the networks with private IP address space.

Traditionally, the network processor provides all functionality to create the IP tunnel, with tunneling being done before the queuing point, i.e. the network processor precedes a queuing or traffic management module. The network processor accordingly first processes packets, provides them with security features and then sends the packets to the traffic management module for queuing. Parts of the IPSec header added during the security processing are a field code and sequence number for ensuring that the packets are transmitted on the IP tunnels in the correct order, and received at the tunnel end point in the correct order.

The sequence number is a monotonically increasing number which is also specifically used to prevent replay attacks. An anti-replay check in a receiving routing device assesses the sequence number of a packet and moves an anti-replay or sliding window forward with each packet received having a higher sequence number. Using this method, packets will be discarded whenever their sequence numbers are older than the allowable length of the anti-replay window.

A replay attack occurs where an eavesdropper saves already traversed packets and sends them at a later point of time. When networks are bombarded with large amounts of these old packets, network failure may occur.

First adding the sequence number to a packet and then feeding the packet to the traffic management module for queuing may result in the packets getting out of order. This is due to the fact that the traffic management module ignores the sequence number, as it is only concerned with the quality of service (QoS) in the IP tunnel. For example, if the traffic management module sees that within a certain IPSec tunnel there is a higher priority packet (for example a Voice-over-IP (VoIP) packet), the traffic management module will first transmit this higher priority packet, with low latency, ahead of any of the other packets, even though the VoIP packet's sequence number is higher than the other packet's sequence numbers.

It follows that packets belonging to same IP tunnel but having different classes of service can go out of order after the queuing point to the extent that an anti-replay check in a receiving routing device mark the low priority packets having lower sequence numbers arriving later than the high priority packets having higher sequence numbers, as old copies and discards them. As mentioned, the anti-replay check will move the anti-replay window forward for a higher sequence number and cause the late arriving low priority packets with smaller sequence numbers to drop out of the anti-replay window. Processing of packets before the queuing point consequently has an impact on the QoS.

### BRIEF DESCRIPTION OF THE DRAWINGS

The embodiments are illustrated by way of example and not limitation in the figures of the accompanying drawings, in which like references indicate similar elements and in which:

FIG. 1 is a high level schematic diagram depicting a typical Internet Protocol security network containing a virtual path or tunnel between two network points or routing devices;

FIG. 2 is a block diagram illustrating a routing system for routing data over an Internet Protocol security network according to an example embodiment;

FIG. 3 is a simplified flow diagram illustrating a method, in accordance with an example embodiment, of routing data over an Internet Protocol security network;

FIG. 4 shows a flow diagram of the different operations for controlling the order of processing of packets fed from a network processing module to a traffic management module;

FIG. 5 shows a flow diagram of the different operations for determining whether a packet requires security features;

FIG. 6A and FIG. 6B show flow diagrams of the different operations for providing a packet with security features;

FIG. 7A shows the packet format of a packet that is fed to the post-queue line interface module;

FIG. 7B shows the packet format of the packet shown in FIG. 7A before it is sent to a cryptography module for encryption;

FIG. 7C shows the packet format of the packet shown in FIG. 7B in an embedded cryptography module;

FIG. 7D shows the packet format of the final packet including the correct tunnel information after the cryptography module has built and prepended a tunnel header to the packet;

FIG. 8A shows the packet format of an inbound packet at a post-queue line interface module of a receiving routing device;

FIG. 8B shows the packet format of the packet shown in FIG. 8A in the cryptography module of the post-queue line interface module of the receiving routing device;

FIG. 8C shows the packet format of the packet shown in FIG. 8B in the embedded cryptography module;

FIG. 8D shows the packet format of the packet shown in FIG. 8C after decryption, at the output of the cryptography module; and

FIG. 9 shows a diagrammatic representation of machine in the exemplary form of a computer system within which a set of instructions, for causing the machine to perform any one or more of the methodologies discussed herein, may be executed.

### DETAILED DESCRIPTION

The present application relates to a routing system and method for routing data over an Internet Protocol security (IPSec) network. The system utilized typically transmits data in the form of packets, with each packet having a specific format.

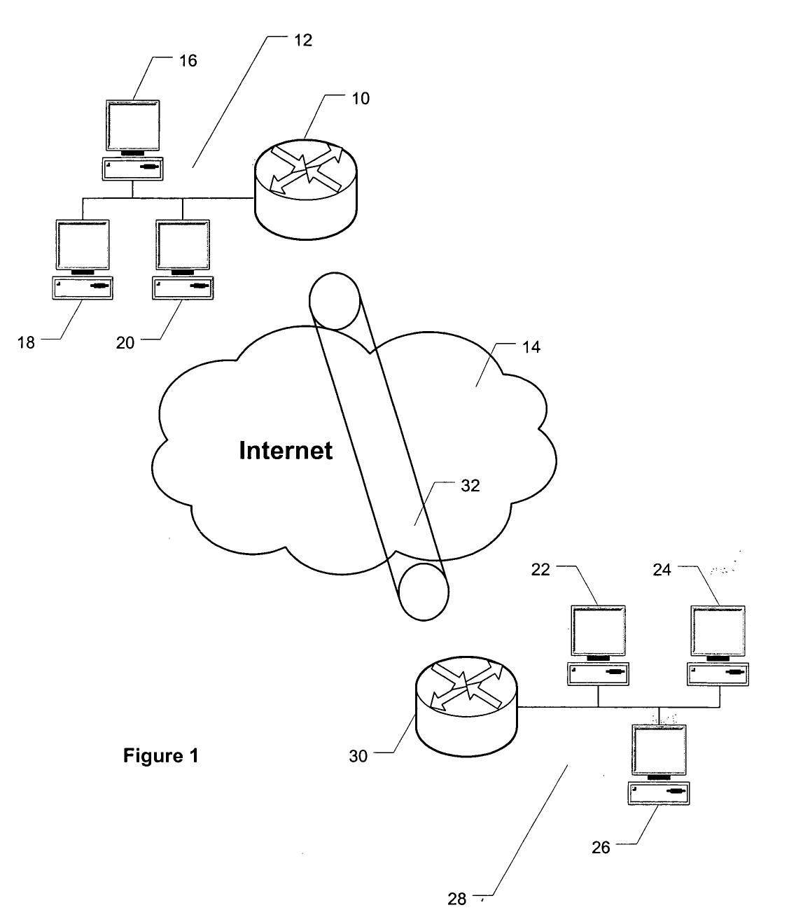

FIG. 1 shows an IPSec network, according to an example embodiment, with a routing system 10 connecting a user private network 12 to the Internet 14. Users 16, 18 and 20 are connected as part of the user private network 12. Likewise, users 22, 24 and 26 are connected as part of user private network 28, with a routing system 30 connecting the user private network 28 to the Internet 14.

As mentioned above, IPSec is a standard providing infrastructure for supporting secure Internet Protocol communications by encrypting and/or authenticating Internet Protocol data packets, thereby to provide a virtual path or IP tunnel 32 within the IP network and across the Internet 14. This IP tunnel 32 forms a “virtual private network (VPN)” between the routing system 10 on the one end of the IP tunnel 32 and the routing system 30 on the other end of the IP tunnel 32.

An example embodiment may find application in IPSec Encapsulating Security Payload (ESP) tunnels and will be described, by way of example, according to ESP tunnel mode, where the Type of Service (TOS) bits of the packets are not modified along the tunnel. However, it will be appreciated by a person skilled in the art that the example embodiments can also find application in the IPSec transport modes, either multi-hop, where the TOS bits are not modified or single-hop IPSec VPN applications where Customer Edge (CE) and Provider Edge (PE) routing systems are directly connected.

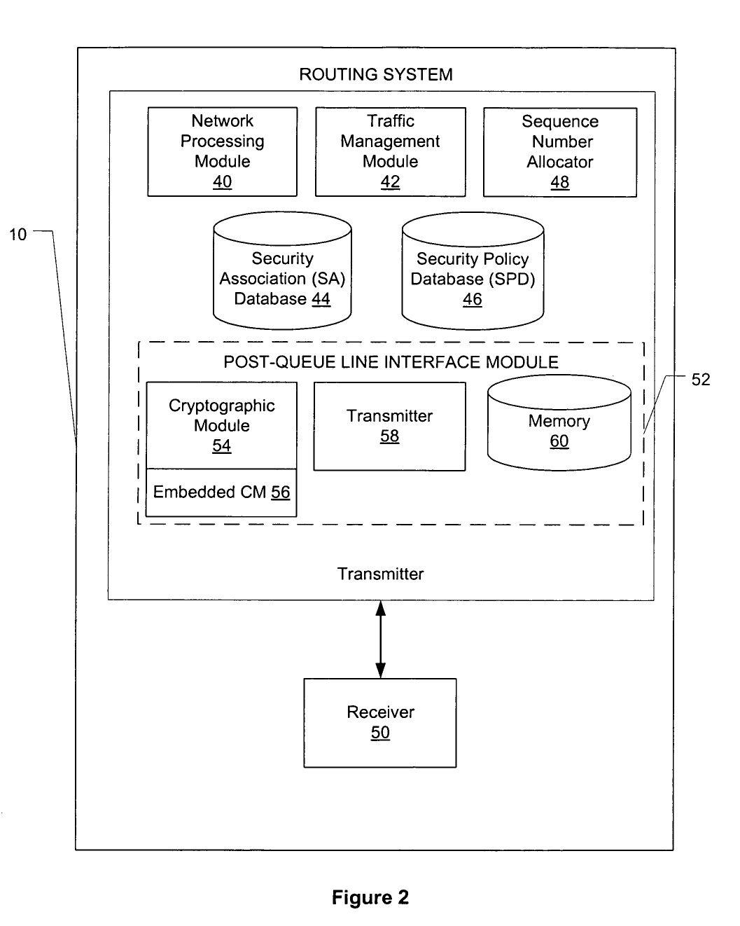

FIG. 2 shows a block diagram of a routing system for routing data over an Internet Protocol security network according to an example embodiment. Although routing system 10 of FIG. 1 is described in detail as the transmitting routing system, it will be appreciated that routing system 30, which receives the packet, may have a similar configuration.

Turning to FIG. 2 the routing system 10 is shown to include a network processing module 40, a traffic management module 42, a Security Association (SA) database 44 and a security policy database (SPD) 46. The routing system 10 is further shown to include a sequence number allocator 48 and a receiver 50. A post-queue line interface module (e.g. ASIC) 52, which includes a cryptographic module 54, a transmitter 58 and a post-queue line interface memory 60 also forms part of the routing system 10.

Routing system 10 is a junction between two networks and transfers packets between the different networks 12 and 28 over the Internet 14 (see FIG. 1). In order to route packets, routing system 10 communicates with other routers, e.g. routing system 30, using different routing protocols.

The network processing module 40 processes each inbound and outbound packet received via the receiver 50 by communicating with the traffic management module 42, the Security Association (SA) database 44 and the security policy database (SPD) 46. The network processing module 40 also feeds packets to the traffic management module 42 and the post-queue line interface module 52.

The traffic management module 42 is responsible for controlling the processing of packets, controlling the order of processing of packets and the buffering of packets. The traffic management module 42 may assess the priority of a packet according to scheduling algorithms, with traffic management being part of packet classification and quality of service (QoS) schemes. For example, a packet which has a Type of Service (TOS) which requires a high level of priority would be placed on the highest priority queue, to be serviced first. The traffic management module 42 identifies the priority of each packet, places the packet in the appropriate queue and then services and processes the queues in the correct order.

Low latency packets have a high priority and should be transmitted to their destinations with minimum delays. Typical low latency packets include VoIP packets, video data packets and other packets where a high level of priority has been specified, e.g. Internet traffic that has to be guaranteed. Low latency packets are accordingly placed in a high priority queue. High latency or latency insensitive packets have a low level of priority and are typically delayed to ensure that low latency packets are transmitted first.

The traffic management module 42 may include memory buffers in which packets are queued and stored during periods of peak traffic.

A Security Association (SA) describes a unidirectional secured flow of data between two IPSec systems. The SA database 44 may contain all the security associations that are either created manually or automatically through negotiation, using Internet Key Exchange (IKE). Internet Key Exchange is a protocol used to set up a Security Association in the IPSec protocol. IKE uses a key exchange to set up a shared session secret, from which cryptographic keys are derived. To mutually authenticate the communication parties, public keys or preshared keys may be used.

Each Security Association is defined by a destination address, a Security Parameter Index (SPI) and a security protocol (IPSec protocol). The SPI is used in combination with an IP address, typically the destination address, and the security protocol to identify the security parameters, e.g., the Security Association, for each packet.

The SPD 46 may contain the security services to be offered to IP traffic. These security services are classified by a set of fields of the IP packet called a selector and includes, for each packet, Source IP Address, Destination IP address, IP Protocol, Source Port and Destination Port. Each entry in the SPD 46 is indexed by the selector and specifies the action to be performed on the IP packet, which may be to discard the packet, pass the packet through for normal forwarding or process the packet to provide the packet with IPSec features. In the last mentioned case the SPD entry points to a Security Association.

The receiver 50 of the routing system 10 receives packets from other networks for inbound or outbound processing.

The sequence number allocator 48 generates and allocates a sequence number for each packet after the traffic management module 42 has identified the priority, queued and processed the packet. The sequence number may be a 32-bit, incrementally increasing number that indicates the packet number sent over the Security Association of the communication. On the receiver side of the network, this field will be checked to verify that the packet has not already been received and that the packet is not too old. In these circumstances, the packet will be rejected and discarded.

The post-queue line interface module 52 includes a cryptography module 54, the transmitter 58 and the post-queue line interface memory 60. The post-queue line interface module 52 is responsible for providing a packet with Internet Protocol security.

The cryptography module 54 includes an embedded cryptography module (CM) 56 and processes the packet to create an encrypted packet by communicating with the SA database 44, incrementing the sequence number, hashing the packet according to ESP protocol and returning an Integrity Check Value (ICV) along with the processed packet. The ICV results from the application of optional ESP authentication.

The cryptography module 54 also determines if and how many padding bytes are required for the packet, updates the counter containing the number of encrypted bytes sent from the Security Association (excluding padding, pad length and NH (next header)) if the Security Association is using the number of bytes as its lifetime. The cryptography module 54 builds the tunnel header, prepends it to the packet, and outputs the final packet with the correct tunnel format to the transmitter 58, which sends the packet over the Internet through the virtual tunnel 32.

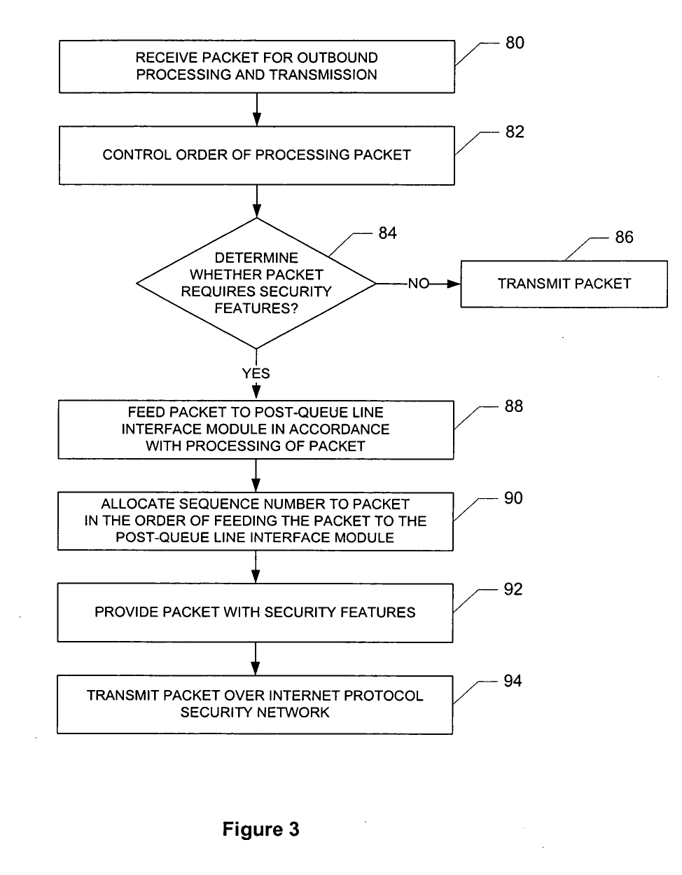

FIG. 3 is a simplified flow diagram illustrating a method, in accordance with an example embodiment, of routing data over an Internet Protocol security network.

At operation 80 a packet for outbound processing and transmission over the Internet Protocol security network is received by the receiver 50 of the routing system 10. The network processing module 40 feeds the packet to the traffic management module 42 which controls the order of processing the packet and other packets received via the network processing module 40 in operation 82.

In decision 84 the network processing module 40 determines, by accessing the SPD 46, whether the packet requires security features. In the event that no security features are required for the packet, the packet is sent over the Internet without further processing (operation 86). However, if the packet should undergo security processing, the network processing module 40 feeds the packet to the post-queue line interface module 52 in the order the packets were processed and serviced by the traffic management module 42 in operation 82.

The sequence number allocator 48 allocates, in operation 90, a sequence number to the packet in the order the packets were fed to the post-queue line interface module 52. In operation 92 the appropriate security features are provided to the packet by the post-queue line interface module and particularly by the cryptographic module 54 and the embedded cryptography module 56.

Once the packet has been provided with the appropriate security features it is transmitted to its destination address, in operation 94, over the Internet Protocol security network by the transmitter 58.

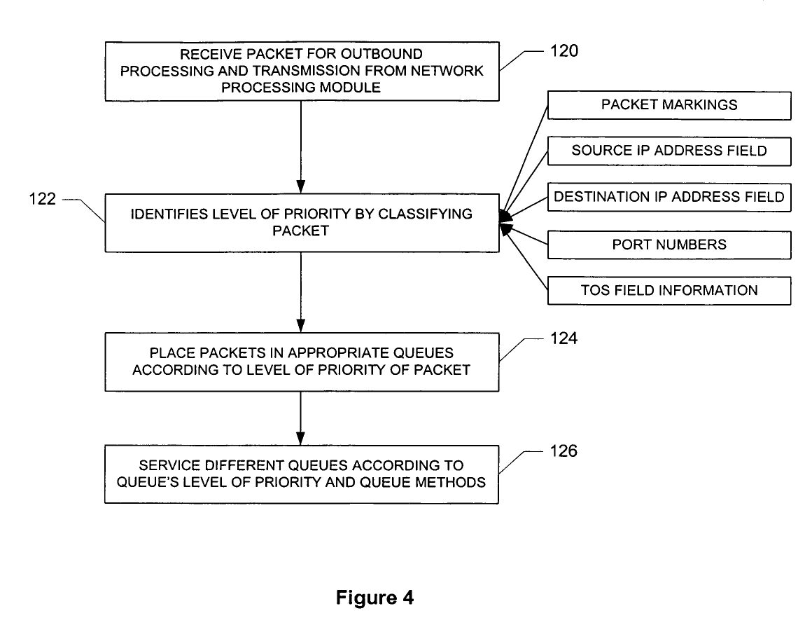

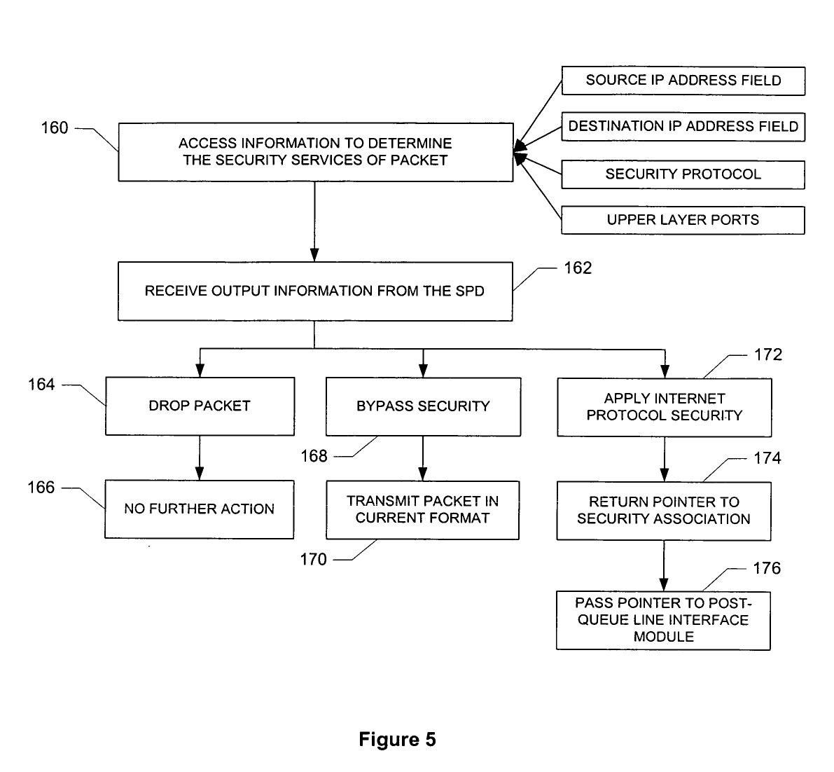

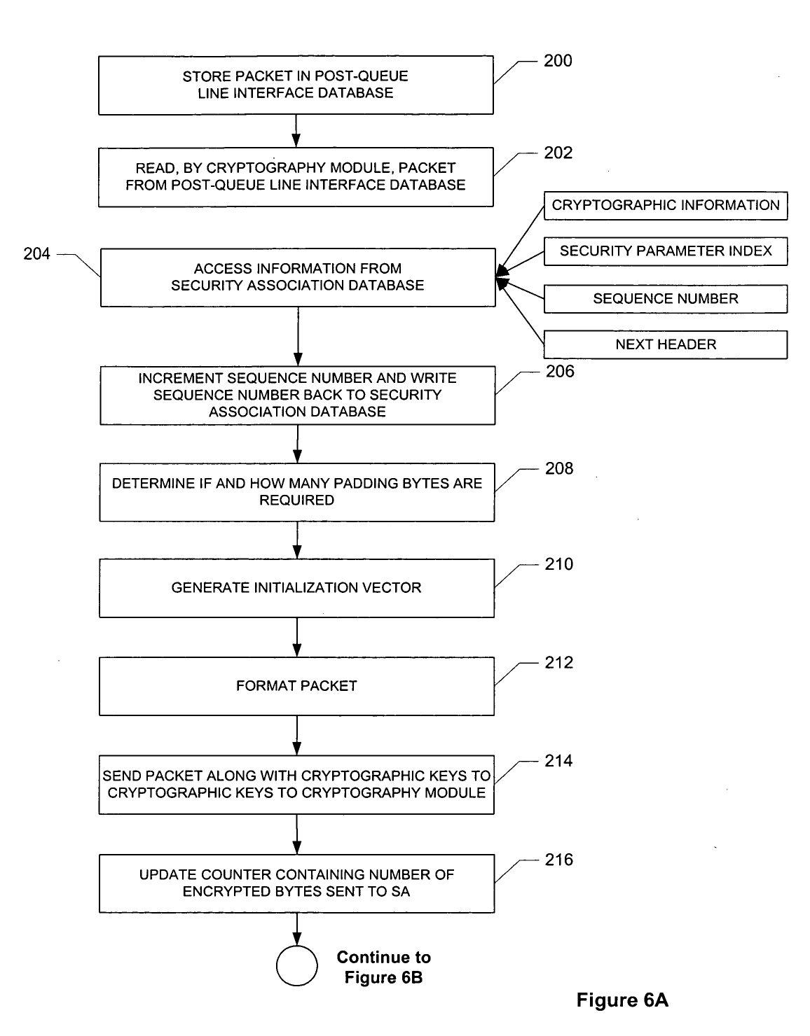

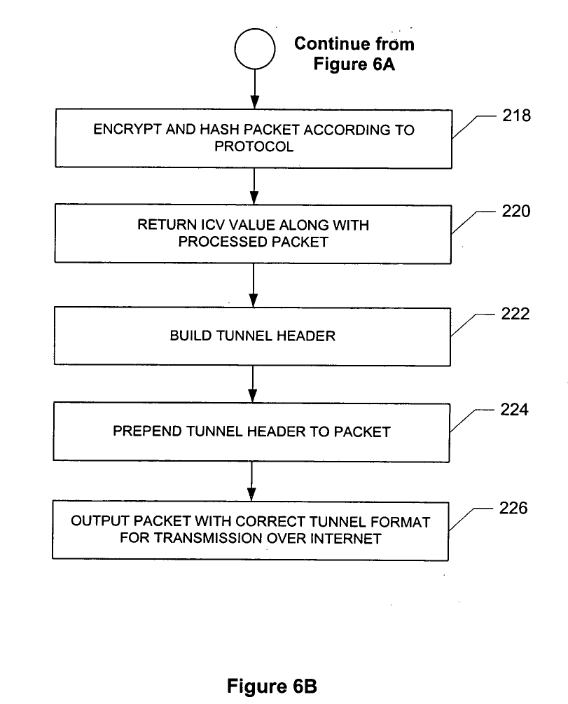

The simplified flow diagram of FIG. 3 will now be described, with more example detail according to FIG. 4, FIG. 5 and FIGS. 6A and 6B.

FIG. 4 shows a flow diagram of different example operations for controlling the order of processing of packets fed from the network processing module 40 to the traffic management module 42 as shown in operation 82 of FIG. 3. The traffic management module 42 receives the packet from the network processing module 40 in operation 120. In operation 122 the traffic management module 42 identifies the level of priority of the packet by classifying the packet, for example, according to packet markings, source and destination IP address fields, port numbers and information in the TOS field.

Once the traffic management module 42 has identified the level of priority of packets, the packets are placed in the appropriate queue in the traffic management module 42 in operation 124. In operation 126 the traffic management module 42 services the different queues according to their level of priority and according to the queuing methods used. For example, the traffic management module 42 may make use of priority queuing where multiple queues are used and with each queue being serviced with a different level of priority, the highest priority queues being serviced first. Examples of alternatively queuing methods are fair queuing, weighted fair queuing (WFQ) or class based queuing (CBQ).

The different operations determining whether a packet requires security features (operation 84 in FIG. 3) is shown in FIG. 5.

The network processing module 40 accesses information on the SPD 46 to determine the security services for the packet in operation 160. The selectors for the SPD lookup information may be:
Source and Destination Address
Protocol
Upper layer ports

In operation 162 output information is received from the SPD 46 and may include instructions to discard the packet (operation 164), which results in no further action being taken (operation 166). The output information may further alternatively include instructions to bypass security (operation 168), in which case the packet is transmitted without security features in its present format (operation 170) or to apply Internet Protocol security on the packet (operation 172).

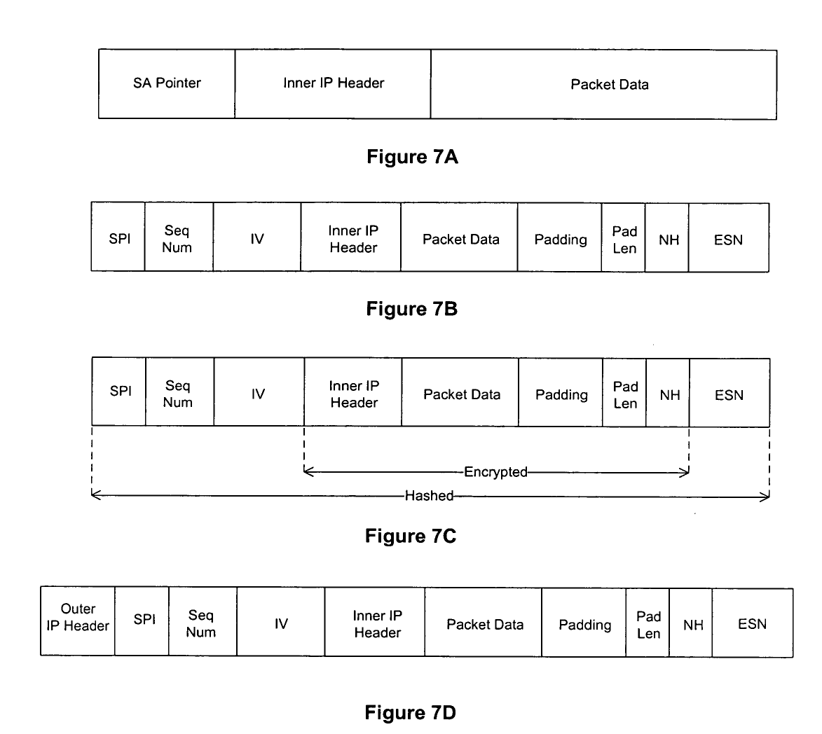

If security is to be applied to the packet, the SPD 46 returns a pointer to the Security Association in operation 174. The network processing module 40 passes this pointer, in operation 176, to the post-queue line interface module 52. FIG. 7A shows the packet format of the packet that is passed to the post-queue line interface module 52 and includes the SA pointer, the inner IP header and the packet data.

FIG. 6A and FIG. 6B show flow diagrams of the different operations for providing the packet with security features (operation 92 of FIG. 3).

In operation 200 the post-queue line interface module 52 stores the packet in the post-queue line interface memory 60. In the event that the packet has to be provided with security features, e.g., IPSec tunneling is required, the cryptography module 54 reads the packet from the post-queue line interface memory 60 in operation 202. The cryptography module 54 may use the SA pointer provided by the network processing module 40 and stored in the post-queue line interface memory 60 to accesses information in the SA database 44 (operation 204). The SA database 44 may provide the following information to the cryptography module 54:
Cryptographic information (protocols, keys etc)
Security Parameter Index (SPI)
Sequence Number
Next Header (NH)

The sequence number has been generated, as previously described, by the sequence number allocator 48 and has been stored in the SA database 44.

In operation 206 the cryptography module 54 increments the sequence number and writes the sequence number back in the SA database 44. The cryptography module 54 determines if and how many padding bytes are required for the packet (operation 208). The SA database 44 generates an Initialization Vector (IV) in operation 210, formats the packet as shown in FIG. 7B (operation 212) and sends the packet along with the cryptographic keys to the embedded cryptography module 56.

In operation 216 the cryptography module 54 updates the counter containing the number of encrypted bytes sent from the Security Association (excluding padding, pad length and NH) if the Security Association is using the number of bytes as its lifetime.

The embedded cryptography module 56 encrypts and hashes the packet according to ESP protocol in operation 218 and returns the ICV value along with the processed packet to the cryptography module (operation 220). The packet format of the packet inside the embedded cryptography module 56 is shown in FIG. 7C.

In operation 222 the cryptography module 54 builds the tunnel header, prepends it to the packet (operation 224), and outputs the final packet with the correct tunnel format (operation 226) as shown in FIG. 7D.

Alternatively, the entire tunnel header may be passed to the cryptography module 54 by the network processing module 40, in which case the cryptography module 54 will only update the “Total Length” field of the outer IP header and recalculate the checksum.

In other types of network systems, the network processing module 40 may look up and pass the tunnel header to the post-queue line interface module 42 and not the cryptography module 54.

Once security features have been provided to packets, they are transmitted over the IPSec ESP tunnel. As the sequence number for each packet is allocated according to the order of processing and servicing the packet in the traffic management module 42, and as the packets are fed in this order to the post-queue line interface module 52, the packets are transmitted over the IP tunnel in the order of their sequence numbers. This may improve the QoS for the traffic transmission, as it prevents the QoS problem associated with the anti-replay window of the receiving routing device, e.g., discarding packets that appear to be “old”.

The process of receiving inbound packets is now described by way of example, in more detail. In this description it is assumed that the configuration of the receiving routing system, e.g., routing system 30, is similar to the configuration of routing system 10, as described above.

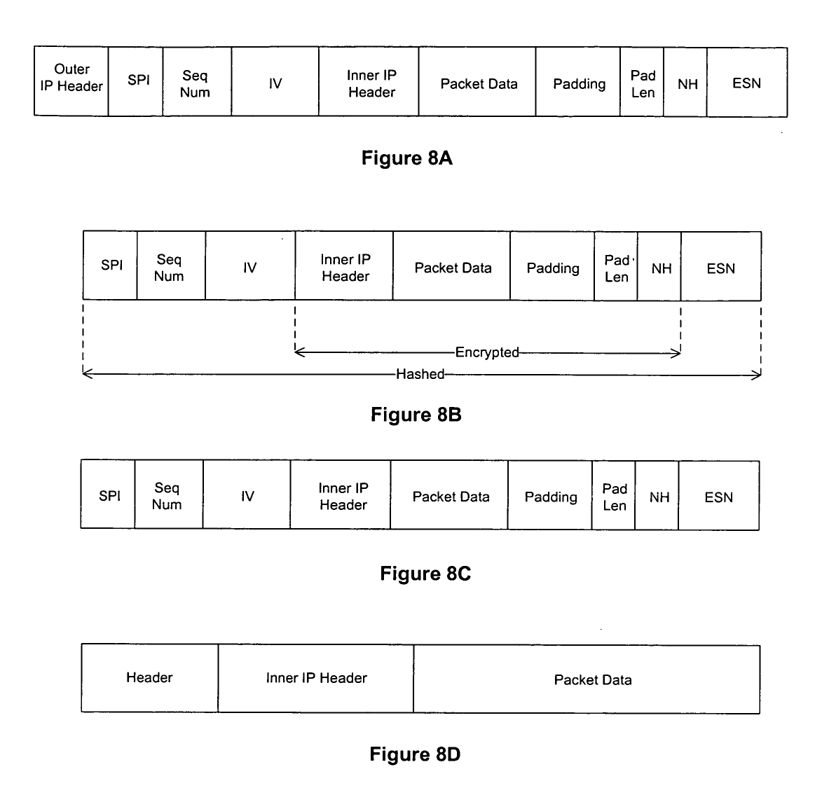

The post-queue line interface module of the receiving routing system receives the inbound packet in the packet format as shown in FIG. 8A. The post-queue line interface module extracts the example selectors listed below from the packet and accesses information through a lookup which returns a pointer to the SA database. The information may, for example, include:
Source and Destination Address from outer IP header
Protocol from outer IP header
SPI from the ESP header

The post-queue line interface module of the receiving routing system now validates the ICV, removes the outer IP header and writes the rest of the packet along with the SA pointer to the post-queue line interface module memory. Upon reading the packet out of this memory, the cryptography module may look up the SA database with the SA pointer. The following information may be obtained from the SA lookup:
Cryptographic information (protocols, keys etc)
Anti-replay attributes
Most recent Extended Sequence Number (ESN)

The cryptography module may extract the sequence number from the packet, verify the sequence number against the left edge of the anti-replay window and against the anti-replay bitmap. This is to confirm that the packet is not a duplicate packet or too old. Should the packet be a duplicate packet or too old, the packet will be sent to the network processing module with proper indication and without further processing in the cryptography module.

Alternatively, the cryptography module will send the packet, as shown in FIG. 8B, along with the cryptographic keys, to the embedded cryptography module.

The embedded cryptography module inside the cryptography module hashes and decrypts the packet according to ESP protocol and returns the ICV value along with the processed packet. The format of the packet inside the embedded cryptography module is shown in FIG. 8C. In the event that the authentication of the packet has been successful, the cryptography module updates the ESN and the anti-replay attributes in the SA database. The cryptography module also removes the ESP header and trailer and sends the packet (along with other information the network processing module may need) to the network processing module. This packet is shown in FIG. 8D.

The network processing module now uses the inner IP header selectors to determine if the SA that was used to process the packet was in fact established to process a packet from the actual source.

The example embodiments may facilitate increased quality of service for communication over an Internet Protocol security network, by first allowing packets to be queued by the traffic management module before allocating a sequence number to each packet. Once a sequence number has been allocated to a packet, the packet is provided with security features and transmitted over the Internet Protocol security network.

As mentioned, although example embodiments have been described according to IPSec ESP protocol, a person skilled in the art would appreciate that the invention also applies to other protocols where sequence numbering and anti-replay windows are used.

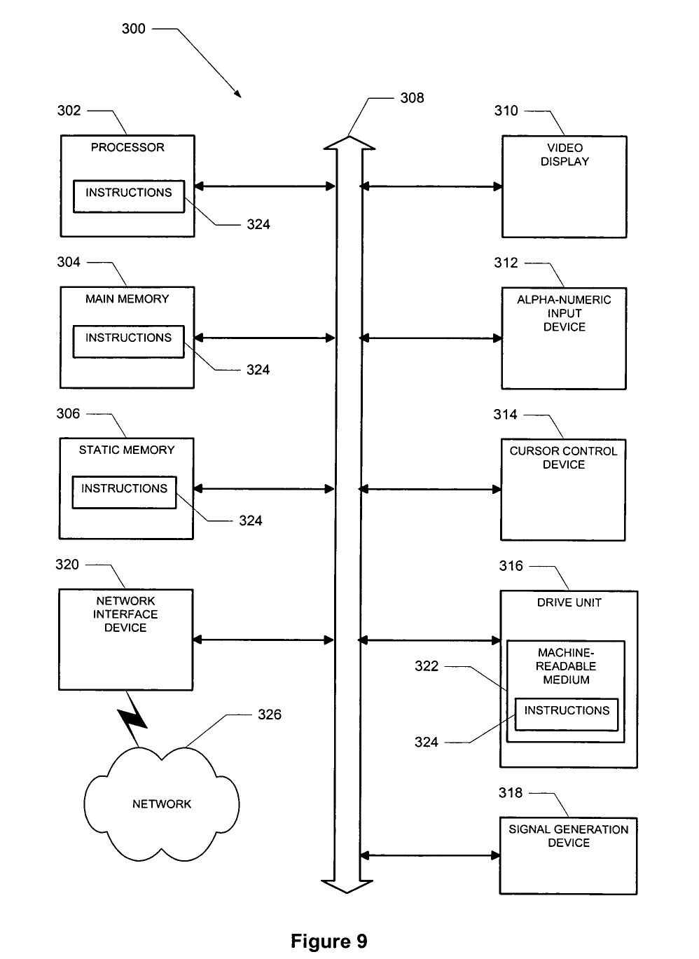

FIG. 9 shows a diagrammatic representation of machine in the exemplary form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU), a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a user interface (UI) navigation device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions and data structures (e.g., software 324) embodying or utilized by any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320 utilizing any one of a number of well-known transfer protocols (e.g., HTTP).

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

What is claimed is:

1. A method of communicating data over an Internet Protocol security network, the method comprising:
receiving packets for transmission over the Internet Protocol security network;
controlling order of processing of the packets;
determining whether each packet requires security features;
feeding the packets to a post-queue line interface module according to the order of processing of the packets;
allocating, in response to the determination that a packet requires security features, a sequence number to each packet in the order of feeding of packets to the post-queue line interface module;
providing said packet with appropriate security features; and
transmitting said packet over the Internet Protocol security network.

2. The method of claim 1 wherein controlling the order of processing of the packets comprises:
identifying the level of priority of each packet,
placing each packet in an appropriate queue in a traffic management module; and
servicing the queue according to the level of priority of the queue.

3. The method of claim 2 wherein determining whether each packet requires security features comprises accessing information on a security policy database.

4. The method of claim 3 wherein the information on the security policy database comprises source and destination address fields and security protocol information.

5. The method of claim 1 wherein the providing said packet with security features comprises accessing information on a Security Association database.

6. The method of claim 5 comprising formatting of said packet and sending said packet with cryptographic keys obtained from the Security Association database to an embedded cryptography module.

7. The method of claim 6 comprising hashing the formatted packet to sign the packet for integrity.

8. The method of claim 7 comprising encrypting the formatted packet and prepending a header to the formatted packet.

9. The method of claim 8 wherein the quality of service of transmitting the processed packets is improved as processed packets are received in the order of being transmitted over the Internet Protocol security network.

10. A system for routing data over an Internet Protocol security network, the system comprising:
a traffic management module to control the order of processing of packets;
a sequence number allocator to allocate sequence numbers to packets in the order of processing of packets in the traffic management module and feeding the packets to a post-queue line interface module;
a post-queue line interface module to provide packets with the appropriate security features; and
a transmitter to transmit packets over the Internet Protocol security network.

11. The system of claim 10 wherein the traffic management module identifies the level of priority of each packet, places the packet in an appropriate queue and services the queue according to the level of priority of the queue.

12. The system of claim 11 wherein the post-queue line interface module comprises a cryptography module and an embedded cryptography module to encrypt and to hash a packet.

13. The system of claim 10 comprising a security policy database containing information for determining whether a packet requires security features.

14. The system of claim 10 comprising a Security Association database containing cryptographic information.

15. The system of claim 14 wherein the quality of service of transmitting the processed packets is improved as processed packets are received in the order of being transmitted over the Internet Protocol security network.

16. A machine-readable medium comprising instructions, which when executed by a machine, cause the machine to:
receive packets for transmission over an Internet Protocol security network;
control an order of processing of the packets;
determine whether each packet requires security features;
feed the packets to a post-queue line interface module according to the order of processing of the packets;
allocate, in response to the determination that a packet requires security features, a sequence number to each packet in the order of feeding of packets to the post-queue line interface module;
provide said packet with appropriate security features; and
transmit said packet over the Internet Protocol security network.

17. A system for routing data over an Internet Protocol security network, the system comprising:
means for controlling the order of processing of packets;
means for allocating sequence numbers to packets in the order of processing of packets in the traffic management module and for feeding the packets to the post-queue line interface module;
means for providing packets with the appropriate security features; and
means for transmitting packets over the Internet Protocol security network.
